(19) United States
(12) Patent Application Publication
(10) Pub. No.: US 2012/0191599 A1
(43) Pub. Date: Jul. 26, 2012

(54) ON-LINE CONTENT DISTRIBUTION SYSTEM

(75) Inventor: MARTIN PAUL RIGBY, CAMBRIDGE (GB)

(73) Assignee: PSONAR LIMITED, CAMBRIDGE (GB)

(21) Appl. No.: 13/012,002

(22) Filed: Jan. 24, 2011

(51) Int. Cl. G06Q 30/00; G06Q 40/00; G06F 21/00

(52) U.S. Cl. 705/40; 726/26

(57) ABSTRACT

An on-line content distribution system comprises a number of user terminals operable to enable a user to generate a request for a media file and associate the request with status data indicative of either a first status or a second status. An account database responds to receipt of a request from a user terminal to update account data, based on status data associated with the request. A content database stores media files and is configured to transmit data corresponding to the media file identified in a request by a user. The transmitted data may be formatted to inhibit the utilization of the transmitted media file more than a predetermined number of times without updating the account database. If the download request includes certain status data, it may permit utilization of the transmitted media file more than a predetermined number of times without updating the account database.

### FIELD

The present application concerns on-line distribution of media content. In particular, embodiments of the present invention may concern the selection and distribution of on-line music and other media content via the Internet to mobile devices and media players.

### BACKGROUND

Currently, media content, such as music and video data, is typically stored in electronic form and distributed electronically. This electronic storage and distribution reduces the costs involved in getting the media content to end-users.

iTunes™ by Apple, Inc. is one example of an existing media content delivery system. iTunes™ is a proprietary digital media player application used for playing and organizing digital music files. The application is also an interface to manage content on Apple's iPods™ and iPhones™. The iTunes™ application enables users to connect to the iTunes™ store. Using the iTunes™ application, an end user can purchase media files from the iTunes™ store. The media files are then downloaded onto a personal computer with an iTunes™ musical library installed and then transferred onto a user's iPod™ or iPhone™. A user then can cause the downloaded media file to be played and view the media file in the case of video files or listen to the media file in the case of music or sound files.

In addition to facilitating the downloading of media files onto user devices the iTunes™ application also supports user creation and selection of play lists. In the absence of a play list an iPod™ or iPhone™ can either randomly select stored media files for play or alternatively respond to a user selection of a specific file to be played. When a play list is generated using the iTunes™ application, a user identifies one or more songs that they desire to listen to. The application then proceeds to play those songs either in a specified order or in a random order.

An alternative approach to music delivery is exemplified by the Pandora® Radio System, which provides a music streaming service. At the core of the Pandora® Radio system is an automated music recommendation system. Users enter a song or artist they enjoy and the service responds by playing selections that are musically similar. More specifically each music track available through the Pandora® Radio system is analyzed based on a number of musical attributes such as rhythm syncopation, key tonality, vocal harmony etc. This data provides a measure of musical similarity between two different tracks. The Pandora® Radio system also prompts users to provide feedback on approval or disapproval of individual songs which are played in response to a user's initial identification of a song or artist. This feedback is combined with the musical similarity measures to help select future songs, which are then provided to users via a streaming service.

Last.fm is another example of an existing musical delivery system. Last.fm is a digital rights management based music streaming service. Using the system, users can access a large database of music by track title, artist, album, record label and genre. Additionally users can also generate play lists detailing the music that they which to listen to. The selected music is then streamed to a user's device.

Existing music distributions systems exemplify different approaches to obtaining a revenue stream. In the case of the iTunes system, the sale of music downloads provides the system's primary revenue stream. Individual music tracks are made available for purchase at a cost of between $0.69 and $1.29. Once purchased a media file encoding the selected track, such as an mp3 or acc file, is made available for download onto a user's system. The data is then transmitted and stored on a user's device where it is available for use and re-use.

The Pandora® Radio and Last.fm systems take a different approach. In contrast to the iTunes™ system where complete media files are transmitted to an end user, both Pandora® Radio and Last.fm are examples of music streaming systems. In the Pandora® Radio and Last.fm systems an end user is only ever provided with a transitory copy of a music track, which is immediately over written as more data is sent to an end user's phone or computer. As the end user is not provided with a permanent copy of a media file no purchase is made. Rather the systems are supported through a combination of advertising which is included in the data stream sent to end user's and also through requiring user's to pay a subscription charge for the music streaming service. Various subscription rates tend to be available and users are able to reduce the amount of advertising, which is included in a data stream by paying a higher subscription. The income streams from paid for advertising and subscription payments can then be supplemented by a separate service selling complete music tracks in a similar was to iTunes™.

Existing systems are faced with a common problem, which is how to identify music tracks that a user may be interested in listening to. In the case of Pandora® Radio and Last.fm identifying similar tracks enables the music streaming system to provide a download stream, which a listener likes and hence justifies the user continuing to listen to and potentially pay for the service provided. In the case of system such as iTunes™, identifying additional music which might be of interest enables a user to be presented advertising which can encourage the user to purchase new track downloads.

One approach to addressing this problem is to obtain detailed data about music tracks in terms of artist, genre and musical attributes. Such an approach enables a system to identify similar musical tracks because of such shared characteristics. Although generally quite successful, this approach can have limitations. Frequently users like a variety of different types of music and such tastes can vary depending upon mood. Identifying music, which is merely “more of the same” does not account for the fact that on various occasions a user might wish to hear something a bit different.

Another approach, which attempts to address the variability of user's tastes, is to utilize data concerning purchases by other users. Where two users purchase or select the same track to be played, it is possible that they will also like other tracks purchased by one another other. To facilitate such an approach, algorithms can be provided to analyze such purchase or selection data to identify “similar” purchasing or selection behavior, which might indicate a similarity of tastes. Such an approach does, however, suffer from limitations since many purchases will identify merely the most popular choices, rather than providing useful information about users' shared tastes or interests.

A different approach is one based on user generated play lists. Particularly in the case of streaming based systems such as Pandora® Radio and Last.fm users are able to generate play lists identifying music they wish to listen to. In addition to structuring the content, which is streamed to an individual user, such play lists can also be shared between users. Sharing play lists enables users to provide a recommendation of new music, which their friends may be interested in.

In the case of download-based systems, such as iTunes™, play lists are created by users. However, the use of such play lists in download based systems is limited as although new music can be identified, the cost of purchasing a track out right can act as a disincentive for a user to purchase a track solely on the basis of a recommendation without ever having heard the track.

In view of the above, an alternative music distribution system is desirable which addresses at least some of the limitations of existing systems.

### SUMMARY

In accordance with one aspect of the present invention, a method of distributing media content comprises: providing an account database associating users with account data; providing a content database storing a plurality of media files; receiving a download request from a user for a media file stored in the content database wherein said download request includes data identifying a media file stored in the content database and status data indicative of either a first status or a second status; updating the account data associated with a user making the request on the basis of the status information included in the request; transmitting data corresponding to the media file identified in the received request to a user; and inhibiting the utilization of the transmitted media file more than a predetermined number of times without updating the account database if the download request includes status data indicative of said first status; and permitting utilization of the transmitted media file more than a predetermined number of times without updating the account database if the download request includes status data indicative of said second status.

In some embodiments, inhibiting the utilization of a transmitted media file more than a predetermined number of times without updating the account database if the download request includes status data indicative of said first status may comprise inhibiting the utilization of the transmitted media file more than once without updating the account database if a download request includes status data indicative of said first status. In such embodiments the data transmitted in response to a request including status data indicative of said first status may comprises data in a form which prevents the data from being used more than once. Alternatively the data transmitted in response to a request including status data indicative of said first status may comprise a data stream, which is overwritten subsequent to use thereby preventing the data from being reused more than once.

In some embodiments, transmitting data corresponding to the media file may include transmitting data which identifies the number of times a media file can be used. In such embodiments the method may further comprise receiving an instruction to play a received media file; determining the number of times a received media file is permitted to be used on the basis of the data transmitted with the media file; and playing the received media file if the media file has not been played more than the permitted number of times.

If it is determined that a received media file has been played the permitted number of times, the method may additionally comprise generating a further download request for a media file; updating the account data associated with the user making the request on the basis of the generated request; and transmitting data to a user enabling the user to play the media file at least one more time without updating the account database. The transmitted data enabling the user to play the media file at least one more time may comprise data identifying the number of additional times the user can play said media file without updating the account database. Alternatively transmitting data enabling the user to play the media file at least one more time without updating the account database may comprise transmitting a further copy of the media file to the user to enable the user to play the media file at least one more time without updating the account database.

In some embodiments, updating the account data associated with a user making a request may comprise: checking whether account data associated with the user making the request exceeds a predetermined amount; and responding to a determination that the account data exceeds the predetermined amount by decrementing the account data. If the account data does not exceed the predetermined a user may be presented with a user interface enabling the user to make an additional payment. Transmission of data to the user to enable the user to utilize a requested media may be prevented until confirmation that a payment is being made has been received and the account database has been updated.

When decrementing account data, account data may be decremented by a first amount if a download request includes data indicative of a first status associated with limited permitted use or by a second amount if a download request includes data indicative of a second status indicative of unlimited permitted use wherein the second amount is greater than the first amount.

Permitting the utilization of the transmitted media file more than a predetermined number of times without updating the account database if the download request includes status data indicative of said second status may comprise permitting the utilization of the transmitted media file an unlimited number of times without updating the account database if a download request includes status data indicative of said second status. In some embodiments, this may be achieved by responding to a further download request from a user for a media file by determining whether a user has previously received data corresponding to the media file in response to a request including status data indicative of a second status; and if so transmitting data corresponding to the media file identified in the received request to the user without updating the account data associated with the user. Alternatively, in other embodiments, the data corresponding to a media file transmitted in response to a request including status data indicative of said second status may comprise data in a form which permits the data to be used multiple times.

In another aspect, a method of distributing media content comprises: providing an account database associating users with account data; providing a content database storing a plurality of media files; receiving a play list from a first user, identifying a second user and one or more media files stored in the content database wherein each of said one or more media files is identified with status data indicative of either a first status or a second status; updating account data associated with the first user on the basis of the status data associated with media files in the playlist; transmitting data identifying the one or more media files in the play list to the second user; responding to a down load request from the second user for a media file included in the play list by: transmitting data corresponding to the media file identified in the request; inhibiting the utilization of the transmitted media file more than a predetermined number of times without updating the account database if a media file has previously been associated with status data indicative of said first status; and permitting utilization of the transmitted media file more than a predetermined number of times without updating the account database if the media file is associated with status data indicative of said second status.

In a further aspect, an on-line method of distributing media content comprises: providing an account database associating users with account data; providing a content database storing a plurality of media files; receiving a download request from a user for a media file stored in the content database; updating the account data associated with a user; transmitting data corresponding to the media file identified in the received request to a user; and inhibiting the utilization of the transmitted media file more than a predetermined number of times without updating the account database

In accordance with another aspect, a computer network comprises: a user terminal operable to enable a user to generate a request for a media file and associate the request with status data indicative of either a first status or a second status; an account database associating users with account data and responsive to receipt of a request from a user terminal to update account data associated with a user making the request on the basis of the status data associated with the request; a content database storing a plurality of media files; and a communications system operable to transmit data between said user terminal; said account database and said content database, wherein the content database is responsive to receipt of a request from a user terminal and the updating of the account database to transmit data corresponding to the media file identified in the received request to a user, the data transmitted being such to inhibit the utilization of the transmitted media file more than a predetermined number of times without updating the account database if a download request includes status data indicative of said first status; and permit utilization of the transmitted media file more than a predetermined number of times without updating the account database if the download request includes status data indicative of said second status.

In some embodiments, the content database may be configured to transmit data corresponding to a media file transmitted in response to a request including status data indicative of said first status as a data stream, which is overwritten subsequent to use thereby preventing the data from being reused more than once.

Alternatively, the content database may be configured to transmit data corresponding to a media file transmitted in response to a request which includes transmitting data which identifies the number of times a media file can be used. In such an embodiment a player program may be provided on the user terminal. The player program may then be responsive to receipt of user input to play a received media file to determine the number of times a received media file is permitted to be used on the basis of the data transmitted with the media file; and play the received media file if the media file has not been played more than the permitted number of times.

In such an embodiment, if a player program determines that a received media file has been played a permitted number of times, the player program may respond by generating a further download request for said media file and causing said further download request to be sent to the accounts database. The accounts database may then respond to receipt of such a request by updating the account data associated with the user making the request on the basis of the generated request; and cause the content database to transmit data to the user terminal enabling a user to play the media file at least one more time.

In some embodiments, the account database may be configured to be responsive to a request for a media file to update the account data associated with a user making a request by: checking that account data associated with the user making the request exceeds a predetermined amount; responding to a determination that the account data exceeds the predetermined amount by decrementing the account data. If the account data does not exceed the predetermined amount the user terminal may then present the user with a user interface to make an additional payment and the account database may then respond to receipt of confirmation that a payment is being made by updating the account database. The content database can be prevented from dispatching data to a user until the account database has been updated.

When updating the accounts database in response to a download request, the accounts database may be configured to decrement the account data by a first amount if a download request includes data indicative of a first status or by a second greater amount if a download request includes data indicative of a second status.

In some embodiments, the account database may be responsive to receipt of a further download request from a user for a media file to determine whether the user has previously received data corresponding to the media file in response to a request including status data indicative of a second status; and if so transmit data corresponding to the media file identified in the received request to the user without updating the account data associated with the user.

In some embodiments, multiple user terminals may be provided. In such embodiments, at least some of the user terminals may be operable to enable a first user to input data defining a play list identifying one or more media files stored in the content database and associate the identified media files with status data indicative of either a first status or a second status together with data identifying a second user. The account database may then be responsive to receipt of a playlist to update account data associated with the first user on the basis of the status data associated with media files in the playlist an transmit data identifying the media files in the playlist to a user terminal associated with the second user. After a content list has been dispatched the content database may then be responsive to receipt of a download request from the second user for a media file included in the playlist to: transmit data corresponding to the media file identified in the request; inhibit the utilization of the transmitted media file more than a predetermined number of times without updating the account database if the download request includes status data indicative of said first status; and permit utilization of the transmitted media file more than a predetermined number of times without updating the account database if the download request includes status data indicative of said second status.

In another aspect, a computer network comprises: a user terminal operable to enable a user to generate a request for a media file; an account database associating users with account data and responsive to receipt of a request from a user terminal to update account data associated with a user making the request; a content database storing a plurality of media files; and a communications system operable to transmit data between said user terminal; said account database and said content database, wherein the content database is responsive to receipt of a request from a user terminal and the updating of the account database to transmit data corresponding to the media file identified in the received request to a user, the data transmitted being such to inhibit the utilization of the transmitted media file more than a predetermined number of times without updating the account database.

In another aspect of the present invention, a computer system comprises: a control module operable to receive a request for a media file from a user, said request being associated with either a first status or a second status; an account database associating users with account data and responsive to receipt of a request for a media file from a user to update account data associated with the user making the request on the basis of the status data associated with the request; and a content database storing a plurality of media files; wherein the content database is responsive to receipt of a request for a media file and the updating of the account database to cause data corresponding to the media file identified in the received request to be transmitted to a user, the data transmitted being such to inhibit the utilization of the transmitted media file more than a predetermined number of times without updating the account database if a download request includes status data indicative of said first status; and permit utilization of the transmitted media file more than a predetermined number of times without updating the account database if the download request includes status data indicative of said second status.

In some embodiments, the content database may be configured to transmit data corresponding to a media file in response to a request including status data indicative of said first status as a data stream, which is overwritten subsequent to use thereby preventing the data from being reused more than once.

In some embodiments, the content database may be configured to transmit data corresponding to a media file in response to a request including status data indicative of said first status together with data, which identifies the number of times a transmitted media file can be used.

In some embodiments, the accounts database may be configured to update account data associated with a user making the request on the basis of the status data associated with the request by decrementing the account data by a first amount if a download request includes data indicative of a first status and decrementing the account data by a second amount if a download request includes data indicative of a second status wherein the second amount is greater than the first amount.

In some embodiments, the account database may be configured to be responsive to receipt of a further download request from a user for a media file to determine whether the user has previously received data corresponding to the media file in response to a request including status data indicative of a second status; and if so transmit data corresponding to the media file identified in the received request to the user without updating the account data associated with the user.

In another aspect of the present invention, a non-transitory computer readable medium stores computer interpretable instructions, which when interpreted by a programmable computer cause the computer to become configured as described above.

### BRIEF DESCRIPTION OF THE DRAWINGS

Embodiments of the present invention will now be described in detail with reference to the accompanying drawings in which:

FIG. 1 is a schematic block diagram of an on-line content distribution system;

FIGS. 2A and 2B provide a flow diagram illustrating the processing undertaken by the on-line content distribution system of FIG. 1; and

FIG. 3 is a flow diagram of the processing undertaken when a first user provides a play list of paid for content to a second user.

### DETAILED DESCRIPTION

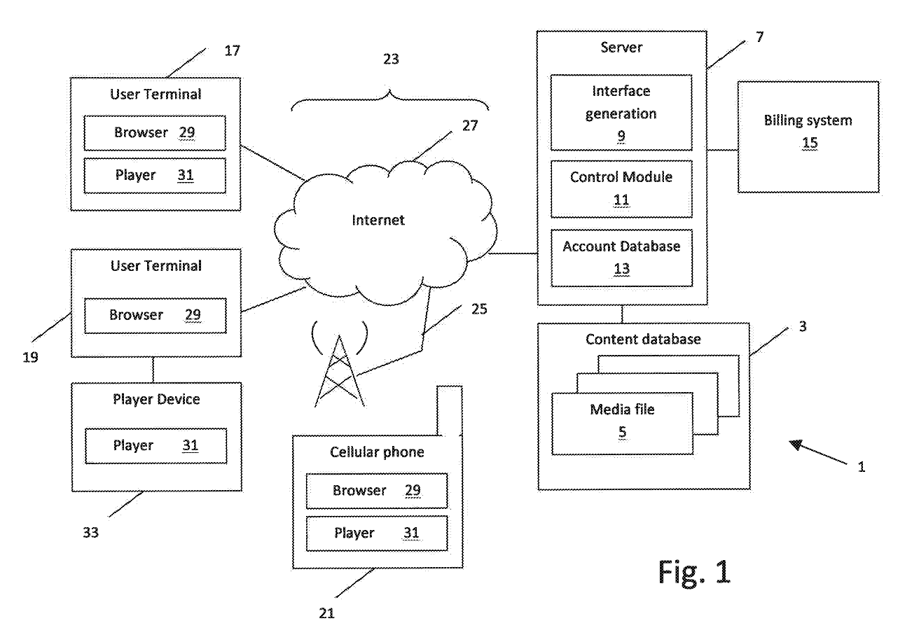

Referring to FIG. 1, an on-line content distribution system 1 is provided. The on-line content distribution system 1 comprises a content database 3 storing media content files 5, such as sound files encoding musical tracks or video images. The content database 3 is connected to a server 7. The server 7 is configured into a number of functional modules comprising an interface generation module 9; a control module 11 and an accounts database 13. The server 7 is also connected to a billing system 15 and is accessible by a number of user terminals 17-21 via a communication system 23. In this embodiment, the user terminals 17-21 comprise computers 17,19 and a mobile cellular telephone 21 and the communications system 23 comprises a cellular telephone network 25 and the Internet 27.

A browser program 29 is provided in memory of each of the user terminals 17-21. As will be described in more detail below, the browser program 29 enables each of the user terminals 17-21 to interact with the interface generation module 9 to cause a user interface enabling a user to identify a media files 5 stored on the content database 3 that they wish to access to be displayed. The interface generation system 9 also enables a user to indicate the manner in which a user wishes to be charged for obtaining access to selected media file 5. When a selection of a media file 5 and status data indicating the selected charging system is received by the server 7, the control module 11 then proceeds to update the accounts database 13 and causes the content database 3 to provide a copy of the requested media file 5 to the user terminals 17, 19, 21 requesting the media file 5. The obtained copy can then be played using a player program 31 provided either in the memory of the user terminal 17, 21 receiving the requested media file 5 or passed to a player device 33 connected to the user terminal 19 which itself contains a player program 33.

Subsequently, after the requested media file 5 has been played, as will be described in more detail below, the content database 3, the player program 33 and the server 7 interact so that the status data associated with a request for a media file 5 determines whether a user can utilize the requested media file 5 on further occasions without the accounts database 13 being updated. The described system thereby enables a differential charging structure to be implemented whereby users can be charged different amounts to be provided with unlimited access to a media file or alternatively to be charged a lesser amount each time a file is accessed.

The described system also facilitates the recommendation and sharing of media files. More specifically, one user can generate a list of recommended media files 5 for another user to access and play. When creating the recommended list, the first user can pay for the second user to be provided with access to the recommended media files 5 a limited number of times before incurring additional charges. As only a limited amount of use is provided the costs for providing others with paid for access to media can be significantly lower than that required under media distribution systems.

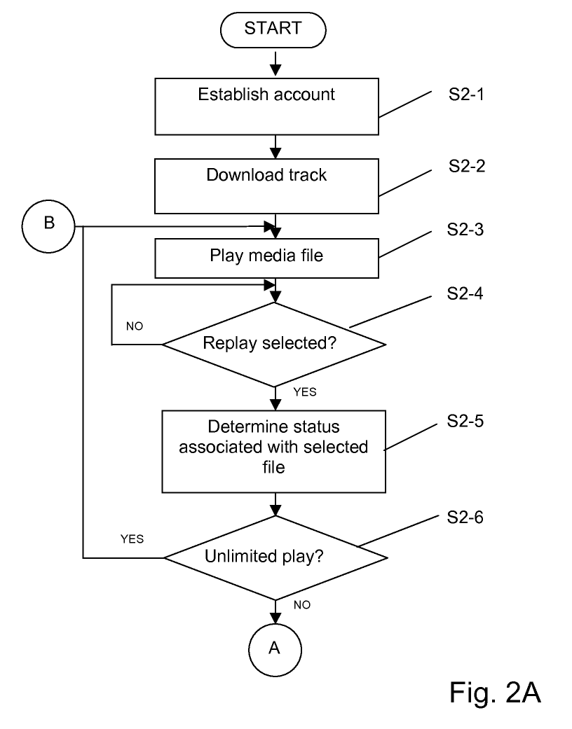

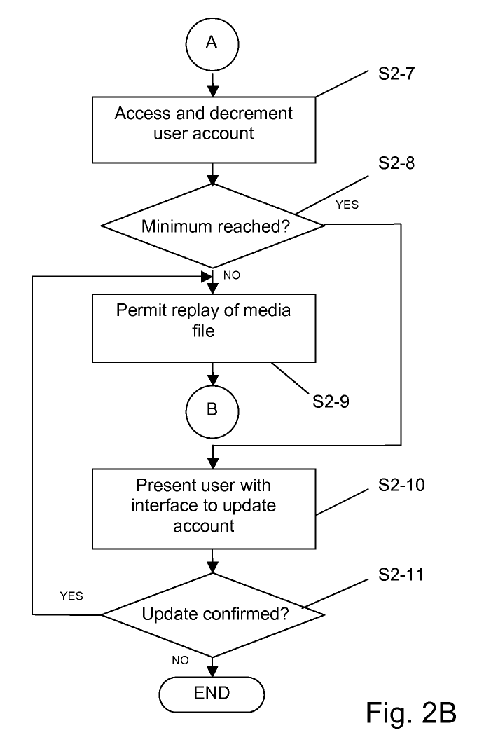

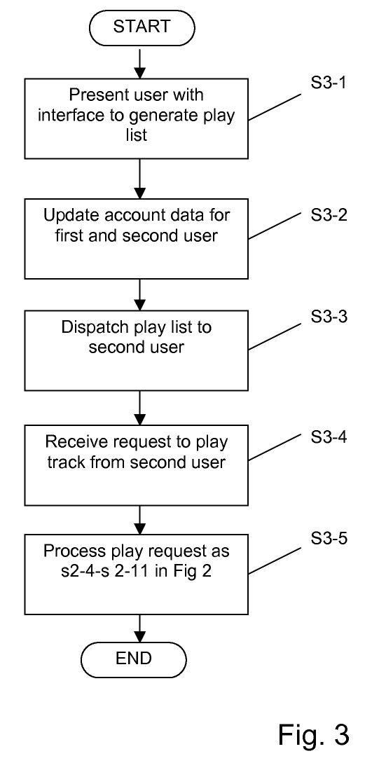

The processing undertaken by the on-line distribution system 1 will now be described with reference to the flow diagram of FIGS. 2A and 2B.

Referring to FIG. 2A, initially in order to utilize the system 1, a user is required to establish (s2-1) an account. In this embodiment, this is achieved by a user utilizing a browser 29 to access the interface generation module 9 on the server 7. The interface generation module 9 then causes a user interface to be displayed on the screen of the user terminal 17-21 accessing the server 7. This can be achieved by the browser 29 being a conventional browser program and the interface generation module 9 being a conventional website. Alternatively, in other embodiments, the same effect can be achieved by the interface generation module 9 providing an application, which is downloaded on a user terminal 17, 19, 21 and provides a similar functionality.

The user interface displayed by the user terminal 17, 19, 21 will then enable the user to enter basic information to establish an account. Typically such information will include a user name, a password, an e-mail address and billing information. This billing information can either be for example the credit card information required to execute a credit card transaction or alternatively where the user terminal being utilized is a cellular phone, data necessary in order to make a charge to a telephone bill. Having obtained this information, the information is sent from the user terminal 17, 19, 21 to the server 7 and a user record is established in the account database 13. The user record, in this embodiment will also include a credit amount. Having established the user record in the account database 13, the control module 11 then proceeds to utilize the received billing information to instruct the billing system 13 to execute a billing transaction for the initial credit amount.

Thus, for example, a user record of the following format might be created and stored in the account database 13:

| User Name: | J Smith |
|---|---|
| Password | 1234ABCDE |
| Billing details | Visa Credit Card No 1212-2222-3333-4444 |
| | Name on Card: J SMITH |
| | Billing address: 57 Acacia Avenue |
| | Anytown, MD 9999-9999, USA |
| Current Credit | $10.00 |

In the case of such a record, the billing system would proceed to charge the $10 using the obtained billing information. Charging in this way reduces overall transaction costs as the credit on the system can be charged in blocks of a certain value and hence avoids making transactions for very small amounts.

Having established an account, a user is then invited to down load (s2-2) and play a media file 5. More specifically, the interface generation module 9 causes the browser 29 to present a user interface enabling a user to select from a menu identifying the media files 5 stored in the content database 3. For each of the files the user is prompted to identify whether they wish to have unlimited access to the file or alternatively to be charged for each use of the file. Both options will be associated with one or more charges. Thus, for example, a charge of $0.99 might be associated with unlimited use of a media file 5 whereas the alternative might be a charge of $0.10 per play for using the file on a single occasion.

Having identified a media file 5 and whether the use desires unlimited use or to pay for each use, this data is then transmitted from the user terminal 17,19,21 to the server 7. The control module 11 then proceeds to instruct the account database to debit the users account by the amount associated with the user's selection and record in the user's account record the access that the user has purchased.

Thus, at this stage, a user's record might appear as the following after a user has selected two files for access, one for unlimited use and one for being charged for each use:

| User Name: | J Smith |
|---|---|
| Password | 1234ABCDE |
| Billing details | Visa Credit Card No 1212-2222-3333-4444 |
| | Name on Card: J SMITH |
| | Billing address: 57 Acacia Avenue |
| | Anytown, USA |
| Current Credit | $8.89 |

Selected tracks

| | |
|---|---|
| Track 1 | Unlimited play |
| Track 2 | Pay per play |

Having updated the user record in the account database 13, the control module 11 then makes a copy of the selected media files 5 available to the user terminal 17, 19, 21.

This can be done in a number of ways depending upon the details of the system 1. In the present embodiment, the media file 5 is transmitted to the user terminal 17 together with data identifying the number of times the media file 5 can be utilized. This copy of the media file 5 is then stored in the memory of the user terminal 17, 21 or the player device 33 connected to the user terminal 19 and when a user wishes to play the media file (s2-3), the player program on the user terminal 17, 21 or player device 33 is invoked and then proceeds to play the downloaded media file 5.

Having played the media file 5 the player program 31 then waits (s2-4) until the user indicates that they wish the media file 5 played again. When the player program 31 is instructed to replay a media file 5, before playing the file 5 the player checks (s2-5, s2-6) the status data associated with the file 5 which indicates the number of times a file can be played without incurring an additional charge.

If the selected media file 5 is associated with data indicating that the file 5 can be reused without additional charge, the player 31 then proceeds to play (s2-3) the file 5 before again waiting for user input (s2-4) to ask for the media file to be reused.

If, however, the player 31 determines the media file 5 has already been used the paid for number of times, the player 31 the accesses the account database 13 on the server 7. The control module 11 then (s2-7) proceeds to decrement the users account by the amount associated with the pay per play option and checks (s2-8) whether this causes the users account to reach a minimum amount. If the minimum amount has not be reached the control module 11 then (s2-9) sends a signal to the player program 31 to permit the player program to re-utilize the received media file 5 and the player program 31 then plays (s2-3) the media file 5.

Thus, in this way, a user's account is debited each time the media file associated with limited play is activated. The system described enables a user to utilize the available file automatically provided credit associated with the user is available.

If the control module 11 determines (s2-8) that a user's account has reached the minimum level, the control module 11 then causes the user interface module 9 to cause (s2-10) the user terminal 17, 19, 21 to display a user interface requesting that a user confirm that they wish to top up their account. If a user confirms that this is acceptable, the control module 11 causes the billing system 15 to be invoked to utilize the billing information associated with the user to action another transaction for a specified amount and the account data associated with the user is updated to reflect the purchase of additional credit. This having been completed the control module 7 then sends a signal to the player 31 attempting to play the selected media track to instruct the track to be played.

It will be appreciated that preventing a player program 31 from playing a track unless account data is updated or a user has purchased unlimited use of a track could be achieved in a number of ways. In some embodiments, as described above, the player program 31 could be designed to check status data prior to playing a media file. In other embodiments rather than providing a user terminal 17 with data representing a complete media file 5 data could be streamed to a user terminal 17, 19, 21 when requested where the streamed data is stored only on a temporary basis. In such an embodiment, whenever a media file 5 was to be replayed new data would need to be obtained from the server 7 and the content database 3 as previously obtained data will have been over written whilst being utilized.

It will, however, be appreciated that providing complete media files 5 which are associated with a set number of permitted plays provides the system with a number of advantages. In particular such an approach separates the need for a device to connect to the server 7 when a track is to be played. Thus, such an approach reduces the amount of data transfer required. Additionally such an approach facilitates asynchronous play of media tracks 5 where a media track is downloaded and then played at a different time.

The above described system also facilitates the sharing of recommended media tracks between users as will now be described with reference to FIG. 3.

As has been noted above in a conventional on-line distribution system, such as iTunes™, it is possible for users to transfer play lists to other users as a way of recommending tracks for purchase. Users can also provide one another with gift cards to facilitate the purchase of tracks identified in play lists. However, as iTunes involves the purchase of a media file 5 without restrictions on the number of times the file is played, such purchases are relatively expensive.

In contrast to such existing systems, the present embodiments facilitate the purchase of limited use or access to certain media files and hence enables users to provide recommendations to others at much lower cost. Such recommendations also facilitate subsequent purchase of a full use track as users are able to try out a recommended media file 5 prior to purchasing an unrestricted use file.

In such a system, initially (s3-1), a user utilizes a browser program 29 to access the interface generation module 9 on the server 7. This then causes the user to be presented with a user interface enabling the user to create a play list and associate the various media files 5 in the play list with status data. More specifically, a user can select from an index of the media files 5 stored in the content database 3 and associate each file with a status indicating limited or unlimited use. The user then identifies an address for a second user to whom the play list is to be sent.

When data identifying the selected tracks and the second user is sent to and received by the server 9 the control module 11 then (s3-2) causes the account database 13 to be updated. More specifically the account data for the first user is debited to reflect the purchase of the tracks identified in the playlist and the record for the second user is updated to reflect a right to utilize those tracks.

Thus, for example, say a first user was to send the following data to the server 7:

| | |
|---|---|
| User Name: | J Smith |
| Password | 1234ABCDE |

Play list

| | |
|---|---|
| Track 3 | Unlimited play |
| Track 4 | Pay per play |
| Second User: | J Jones |

Current credit for the user J Smith would be updated to account for the purchase of access to track 3 and track 4. The account data base would then update the account database for J Jones to include the data identifying Track 3 and track 4 as selected tracks where track 3 was associated with unlimited play and track 4 was associated with limited play.

Having updated the two account records, data identifying track 3 and track 4 and their associated statuses is then dispatched (s3-3) to the second user. Having received this play list the second user can then utilize a player program 31 to play any of the listed tracks. When a track is selected for play a request (s3-4) is dispatched from the second user to the server 7, which identifies the selected track. The control module 11 then processes the request in a similar way to the manner in which a request for a media file 5 is processed as has been described in steps s2-4-s2-11 in FIG. 2.

Thus, in this way, a first user is able to select a set of media files which are to be made available for use by a second user.

Although in the above embodiments reference has been made to making unlimited user of a media file 5, it will be appreciated that in some embodiments media files 5 could be made available for use only a limited number of times before additional payment is required. Similarly, although in the above embodiments media files 5 are described as being made available for use by users only once before needing to update their account data to facilitate further use, it will be appreciated that in some embodiments multiple uses before updating account data could be permitted. Thus, rather than facilitating charging on a unlimited use or charge per use basis, the described system could be amended to facilitate any kind of differential charging scheme whereby users were charged differently dependent upon a user selection of status data to be associated with a user and a selected media file 5.

Although the embodiments of the invention described with reference to the drawings comprise computer apparatus and processes performed in computer apparatus, the invention also extends to computer programs, particularly computer programs on or in a carrier, adapted for putting the invention into practice. The program may be in the form of source or object code or in any other form suitable for use in the implementation of the processes according to the invention. The carrier may be any entity or device capable of carrying the program.

For example, the carrier may comprise a storage medium, such as a ROM, for example a CD ROM or a semiconductor ROM, or a magnetic recording medium, for example a floppy disc or hard disk. Further, the carrier may be a transmissible carrier such as an electrical or optical signal, which may be conveyed via electrical or optical cable or by radio or other means.

When a program is embodied in a signal, which may be conveyed directly by a cable or other device or means, the carrier may be constituted by such cable or other device or means. Alternatively, the carrier may be an integrated circuit in which the program is embedded, the integrated circuit being adapted for performing, or for use in the performance of, the relevant processes.

What is claimed is:

1. A method of distributing media content comprising:
providing an account database associating users with account data;
providing a content database storing a plurality of media files;
receiving a download request from a user for a media file stored in the content database wherein said download request includes data identifying a media file stored in the content database and status data indicative of either a first status or a second status;
updating the account data associated with a user making the request on the basis of the status information included in the request;
transmitting data corresponding to the media file identified in the received request to a user;
inhibiting the utilization of the transmitted media file more than a predetermined number of times without updating the account database if the download request includes status data indicative of said first status; and
permitting utilization of the transmitted media file more than a predetermined number of times without updating the account database if the download request includes status data indicative of said second status.

2. The method of claim 1 wherein inhibiting the utilization of the transmitted media file more than a predetermined number of times without updating the account database if the download request includes status data indicative of said first status comprises inhibiting the utilization of the transmitted media file more than once without updating the account database if a download request includes status data indicative of said first status.

3. The method of claim 2 wherein the data corresponding to the media file transmitted in response to a request including status data indicative of said first status comprises data in a form which prevents the data from being used more than once.

4. The method of claim 2 wherein the data corresponding to the media file transmitted in response to a request including status data indicative of said first status comprises a data stream which is overwritten subsequent to use thereby preventing the data from being reused more than once.

5. The method of claim 1 wherein transmitting data corresponding to the media file includes transmitting data which identifies the number of times a media file can be used, the method further comprising;
receiving an instruction to play a received media file;
determining the number of times a received media file is permitted to be used on the basis of the data transmitted with the media file; and
playing the received media file if the media file has not been played more than the permitted number of times.

6. The method of claim 5, further comprising:
responding to a determination that a received media file has been played the permitted number of times by:
generating a further download request for said media file.
updating the account data associated with the user making the request on the basis of the generated request; and
transmitting data to a user enabling the user to play the media file at least one more time without updating the account database.

7. The method of claim 6 wherein transmitting data to a user enabling the user to play the media file at least one more time comprises transmitting data identifying the number of additional times the user can play said media file without updating the account database.

8. The method of claim 6 wherein transmitting data to a user enabling the user to play the media file at least one more time without updating the account database comprises transmitting a further copy of the media file to the user to enable the user to play the media file at least one more time without updating the account database.

9. The method of claim 1 wherein updating the account data associated with a user making a request comprises:
checking that account data associated with the user making the request exceeds a predetermined amount;
responding to a determination that the account data exceeds the predetermined amount by decrementing the account data;
responding to a determination that the account data does not exceed the predetermined amount by:
presenting the user with a user interface to make an additional payment;
updating the account data in response to confirmation that a payment is being made; and
preventing transmission data to the user to enable the user to utilize a requested media file until the account data has been updated.

10. The method of claim 9 wherein decrementing the account data comprises decrementing the account data by a first amount if a download request includes data indicative of a first status and decrementing the account data by a second amount if a download request includes data indicative of a second status wherein the second amount is greater than the first amount.

11. The method of claim 1 wherein permitting the utilization of the transmitted media file more than a predetermined number of times without updating the account database if the download request includes status data indicative of said second status comprises permitting the utilization of the transmitted media file an unlimited number of times without updating the account database if a download request includes status data indicative of said second status.

12. The method of claim 11 further comprising:
receiving a further download request from a user for a media file;
determining whether the user has previously received data corresponding to the media file in response to a request including status data indicative of a second status; and
if so transmitting data corresponding to the media file identified in the received request to the user without updating the account data associated with the user.

13. The method of claim 11 wherein the data corresponding to the media file identified in the received request transmitted in response to a request including status data indicative of said second status comprises data in a form which permits the data to be used multiple times.

14. A method of distributing media content comprising:
providing an account database associating users with account data;
providing a content database storing a plurality of media files;
receiving a play list from a first user, identifying a second user and one or more media files stored in the content database wherein each of said one or more media files is identified with status data indicative of either a first status or a second status;
updating account data associated with the first user on the basis of the status data associated with media files in the playlist;
transmitting data identifying the one or more media files in the play list to the second user;
responding to a down load request from the second user for a media file included in the play list by:
transmitting data corresponding to the media file identified in the request;
inhibiting the utilization of the transmitted media file more than a predetermined number of times without updating the account database if a media file is associated with status data indicative of said first status; and
permitting utilization of the transmitted media file more than a predetermined number of times without updating the account database if a media file is associated with status data indicative of said second status.

15. An on-line method of distributing media content comprising:
providing an account database associating users with account data;
providing a content database storing a plurality of media files;
receiving a download request from a user for a media file stored in the content database;
updating the account data associated with a user;
transmitting data corresponding to the media file identified in the received request to a user; and
inhibiting the utilization of the transmitted media file more than a predetermined number of times without updating the account database.

16. A computer network comprising:
a user terminal operable to enable a user to generate a request for a media file and associate the request with status data indicative of either a first status or a second status;
an account database associating users with account data and responsive to receipt of a request from a user terminal to update account data associated with a user making the request on the basis of the status data associated with the request;
a content database storing a plurality of media files; and
a communications system operable to transmit data between said user terminal;
said account database and said content database, wherein the content database is responsive to receipt of a request from a user terminal and the updating of the account database to transmit data corresponding to the media file identified in the received request to a user, the data transmitted being such to inhibit the utilization of the transmitted media file more than a predetermined number of times without updating the account database if a download request includes status data indicative of said first status; and permit utilization of the transmitted media file more than a predetermined number of times without updating the account database if the download request includes status data indicative of said second status.

17. The computer network of claim 16 wherein the content database is configured to transmit data corresponding to a media file transmitted in response to a request including status data indicative of said first status as a data stream which is overwritten subsequent to use thereby preventing the data from being reused more than once.

18. The computer network of claim 16 wherein the content database is configured to transmit data corresponding to a media file transmitted in response to a request which includes transmitting data which identifies the number of times a media file can be used; and wherein a player program is provided on the user terminal which is responsive to receipt of user input to play a received media file to
determine the number of times a received media file is permitted to be used on the basis of the data transmitted with the media file; and
play the received media file if the media file has not been played more than the permitted number of times.

19. The computer network of claim 8 wherein the player program is further configured to respond to a determination that a received media file has been played a permitted number of times by:
generating a further download request for said media file and causing said further download request to be sent to the accounts database; and
wherein the accounts database is responsive to receipt of a said request to update the account data associated with the user making the request on the basis of the generated request; and cause the content database to transmit data to the user terminal enabling a user to play the media file at least one more time.

20. The computer network of claim 16 wherein the account database is configured to be responsive to a request for a media file to update the account data associated with a user making a request by:
checking that account data associated with the user making the request exceeds a predetermined amount;
responding to a determination that the account data exceeds the predetermined amount by decrementing the account data; and
responding to a determination that the account data does not exceed the predetermined amount by sending data to the user terminal to cause the user terminal to present the user with a user interface to make an additional payment, wherein the account database is responsive to receipt of confirmation that a payment is being made to update the account database, wherein until the account database is updated, the account database is configured to prevent the content database from dispatching further data to a user to enable the user to utilize a requested media file until the account data has been updated.

21. The computer network of claim 16 wherein the accounts database is configured to update account data associated with a user making the request on the basis of the status data associated with the request by decrementing the account data by a first amount if a download request includes data indicative of a first status and decrementing the account data by a second amount if a download request includes data indicative of a second status wherein the second amount is greater than the first amount.

22. The computer network of claim 16 wherein the account database is responsive to receipt of a further download request from a user for a media file to
determine whether the user has previously received data corresponding to the media file in response to a request including status data indicative of a second status; and
if so transmit data corresponding to the media file identified in the received request to the user without updating the account data associated with the user.

23. The computer network of claim 16 further comprising:
a further user terminal operable to enable a first user to input data defining a play list identifying one or more media files stored in the content database and associate the identified media files with status data indicative of either a first status or a second status together with data identifying a second user;
wherein the account database is responsive to receipt of a playlist to update account data associated with the first user on the basis of the status data associated with media files in the playlist an transmit data identifying the media files in the playlist to a user terminal associated with the second user;
wherein the content database is responsive to receipt of a download request from the second user for a media file included in the playlist to:
transmit data corresponding to the media file identified in the request;
inhibit the utilization of the transmitted media file more than a predetermined number of times without updating the account database if the media file is associated with status data indicative of said first status; and
permit utilization of the transmitted media file more than a predetermined number of times without updating the account database if the media file is associated status data indicative of said second status.

24. A computer network comprising:
a user terminal operable to enable a user to generate a request for a media file;
an account database associating users with account data and responsive to receipt of a request from a user terminal to update account data associated with a user making the request;
a content database storing a plurality of media files; and
a communications system operable to transmit data between said user terminal; said account database and said content database, wherein the content database is responsive to receipt of a request from a user terminal and the updating of the account database to transmit data corresponding to the media file identified in the received request to a user, the data transmitted being such to inhibit the utilization of the transmitted media file more than a predetermined number of times without updating the account database.

25. A computer system comprising:
a control module operable to receive a request for a media file from a user, said request being associated with either a first status or a second status;
an account database associating users with account data, responsive to receipt of a request for a media file from a user to update account data associated with the user making the request on the basis of the status data associated with the request; and
a content database storing a plurality of media files; wherein the content database is responsive to receipt of a request for a media file and the updating of the account database to cause data corresponding to the media file identified in the received request to be transmitted to a user, the data transmitted being such to inhibit the utilization of the transmitted media file more than a predetermined number of times without updating the account database if a download request includes status data indicative of said first status; and permit utilization of the transmitted media file more than a predetermined number of times without updating the account database if the download request includes status data indicative of said second status.

26. The computer system of claim 25 wherein the content database is configured to transmit data corresponding to a media file in response to a request including status data indicative of said first status as a data stream which is overwritten subsequent to use thereby preventing the data from being reused more than once.

27. The computer system of claim 25 wherein the content database is configured to transmit data corresponding to a media file in response to a request including status data indicative of said first status together with data which identifies the number of times a transmitted media file can be used.

28. The computer system of claim 25 wherein the accounts database is configured to update account data associated with a user making the request on the basis of the status data associated with the request by decrementing the account data by a first amount if a download request includes data indicative of a first status and decrementing the account data by a second amount if a download request includes data indicative of a second status wherein the second amount is greater than the first amount.

29. The computer system of claim 25 wherein the account database is responsive to receipt of a further download request from a user for a media file to
determine whether the user has previously received data corresponding to the media file in response to a request including status data indicative of a second status; and
if so transmit data corresponding to the media file identified in the received request to the user without updating the account data associated with the user.

30. A non-transitory computer readable medium storing computer interpretable instructions which when interpreted by a programmable computer cause the computer to become configured as:
a control module operable to receive a request for a media file from a user, said request being associated with either a first status or a second status;
an account database associating users with account data, responsive to receipt of a request for a media file from a user to update account data associated with the user making the request on the basis of the status data associated with the request; and
a content database storing a plurality of media files; wherein the content database is responsive to receipt of a request for a media file and the updating of the account database to cause data corresponding to the media file identified in the received request to be transmitted to a user, the data transmitted being such to inhibit the utilization of the transmitted media file more than a predetermined number of times without updating the account database if a download request includes status data indicative of said first status; and permit utilization of the transmitted media file more than a predetermined number of times without updating the account database if the download request includes status data indicative of said second status.

31. The computer readable medium of claim 30 wherein the instructions cause the content database to become configured to transmit data corresponding to a media file in response to a request including status data indicative of said first status as a data stream which is overwritten subsequent to use thereby preventing the data from being reused more than once.

32. The computer readable medium of claim 30 wherein the instructions cause the content database to become configured to transmit data corresponding to a media file in response to a request including status data indicative of said first status together with data which identifies the number of times a transmitted media file can be used.

33. The computer readable medium of claim 30 wherein the instructions cause the accounts database to become configured to update account data associated with a user making the request on the basis of the status data associated with the request by decrementing the account data by a first amount if a download request includes data indicative of a first status and decrementing the account data by a second amount if a download request includes data indicative of a second status wherein the second amount is greater than the first amount.

34. The computer readable medium of claim 30 wherein the instructions cause the account database to be configured to be responsive to receipt of a further download request from a user for a media file to
determine whether the user has previously received data corresponding to the media file in response to a request including status data indicative of a second status; and
if so transmit data corresponding to the media file identified in the received request to the user without updating the account data associated with the user.
